(19) United States
(12) Patent Application Publication
(10) Pub. No.: US 2017/0273503 A1
(43) Pub. Date: Sep. 28, 2017

(54) Cooking Apparatus

(71) Applicant: Michiel Schuitemaker, Miami Beach, FL (US)

(72) Inventor: Michiel Schuitemaker, Miami Beach, FL (US)

(73) Assignee: Leopard Industries, Inc., Cincinnati, OH (US)

(21) Appl. No.: 15/080,005

(22) Filed: Mar. 24, 2016

(51) Int. Cl. A47J 33/00; F24C 1/16

(52) U.S. Cl. CPC A47J 33/00; F24C 1/16

(57) ABSTRACT

An outdoor cooking apparatus that includes a housing that is adapted to receive a supply of combustible material, and defines an open upper end, as well as a bottom end. Mounted with the housing is a cooking or cooktop member, which defines a top surface, a bottom surface, an outer periphery, and at least one interior opening positioned above the open upper end of the housing. The top surface includes at least a portion that extends downwardly from the outer periphery to the interior opening.

### FIELD OF THE INVENTION

This invention relates to a cooking apparatus for outdoor cooking. It is particularly directed to an apparatus that may be used as an outdoor grill, barbeque, or fire pit.

### BACKGROUND

Outdoor cooking over a fire predates recorded history. Since those times, the majority of outdoor cooking is done with grills and other cooking devices. Kettle grills, gas grills, fire pits, and the like in different forms has existed for many years and are readily available. While such devices are ubiquitous, they have largely been purely utilitarian in nature. For the most part, the cooking devices do not provide desirable location for socialization for a number of reasons.

One shortcoming of such cooking devices is the risk of flare ups from grease dripping from cooking meats. Such flare ups create the risk of burning the food, as well as the cook or others around the device.

In addition to the immediate dangers of flare ups, there has been some research associating the cooking of meat over a flame and an increased exposure to cancer-causing carcinogens known as PAHs and HCAs. While other forms of high-heat cooking may also create PAHs and HCAs, they are more often caused by a combination of smoke and direct flame contact with the food. As such reducing flare ups is desirable.

### SUMMARY OF THE INVENTION

The present invention is directed to an outdoor cooking apparatus. The cooking apparatus comprises a housing that is adapted to receive a supply of combustible material, and defines an open upper end, as well as a bottom end. The bottom end of the housing may be closed or may be open to permit air drafting and ash removal. The housing may also be positioned on top of a stand, and the bottom end of the housing may open to an interior section of the stand.

Mounted with the housing is a cooking or cooktop member. The cooking member, which may also be referred to as a cooktop member, may be permanently mounted to an upper portion of the housing, such as by welding, or may be removably mounted, such as with a locking mechanism. It is also contemplated that the cooking member may be mounted with the housing simply by resting the cooking member on the top of the housing. The cooking member defines a top surface, a bottom surface, an outer periphery, and at least one interior opening positioned above the open upper end of the housing. In a preferred embodiment, the cooking member is a substantially plate-like member. The top surface preferably defines an uninterrupted continuous surface, but may include openings if desired. The top surface also includes at least a portion that extends downwardly from the outer periphery to the interior opening. In a preferred embodiment, the entire top surface extends downwardly from the outer periphery to the interior opening. In some embodiments the entire cooking member may be angled downward toward the interior opening. In other embodiments, only the top surface may be angled downward. The downward extension of the top surface may be of a downwardly sloped configuration, downwardly curved, or variably sloped. In a preferred embodiment, the slope may be of a grade of between about 0.2% and 3%. In a highly preferred embodiment, the slope is between about 0.28% to 0.6%.

The outer periphery of the cooking member may be of any outline, but is preferably of a smoothly curved outline, such as a circle or oval. In other embodiment, the outline may be polygonal. The interior opening of the cooking member may also define any number of outlines, but is again preferably of a smoothly curved shape, such as a circle.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

There is shown in the drawing presently preferred embodiments of the present invention.

FIG. 1 is perspective view of a preferred embodiment of the present invention;

FIG. 2 is an exploded view of the preferred embodiment of FIG. 1;

FIG. 3 is a cross-sectional side view of a preferred embodiment of the cooking member;

FIG. 3A is a blown up view of a portion of FIG. 3.

FIG. 4 is a cross-sectional partial side view of another preferred embodiment of the cooking member wherein the top surface is sloped;

FIG. 5 is a cross-sectional partial side view of another preferred embodiment of the cooking member wherein the cooking member is curved;

FIG. 6 is a perspective view of an alternative preferred embodiment of the present invention; and

FIG. 7 is a perspective view of another preferred embodiment of the present invention;

It should be noted that the drawings of the invention are not to scale. The drawings are merely schematic representations, not intended to portray specific parameters of the invention. The drawings are intended to depict only typical embodiments of the invention, and therefore should not be considered as limiting the scope of the invention. The invention will be described with additional specificity and detail through the use of the accompanying drawings. In the drawings like numbering represents like elements between the drawings.

### DETAILED DESCRIPTION OF THE PREFERRED EMBODIMENTS

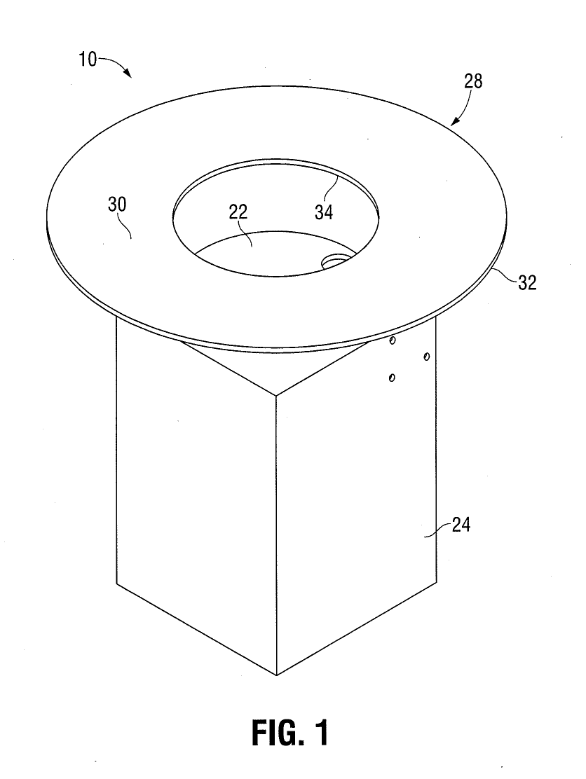

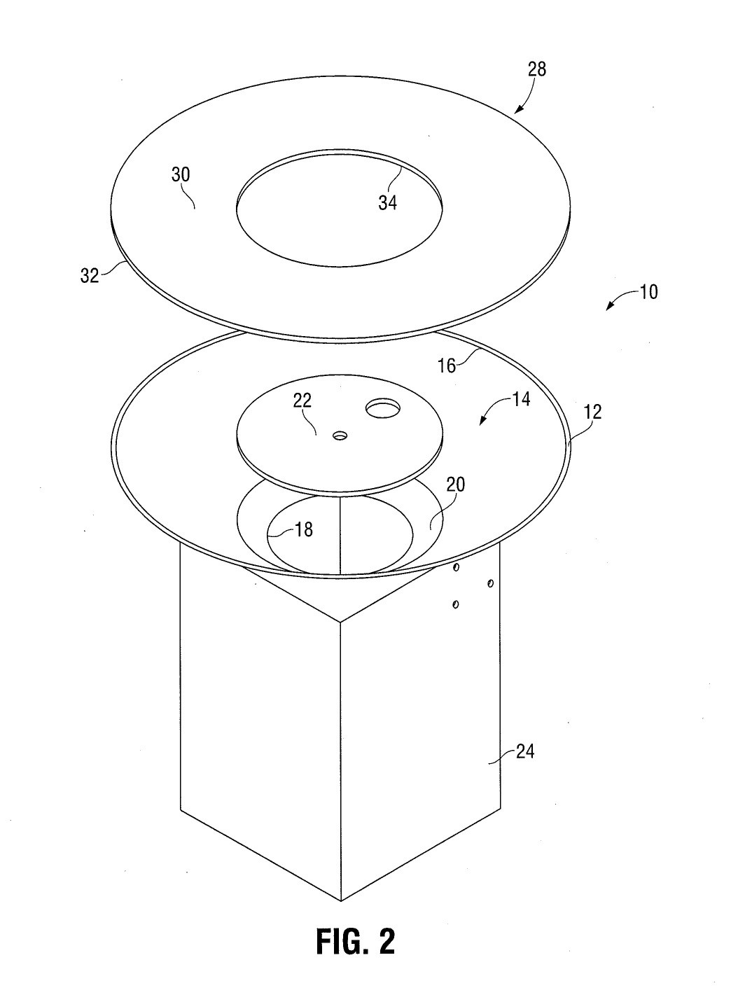

There is shown in FIGS. 1 and 2 of the drawings a preferred embodiment of the present invention. The cooking apparatus 10 comprises a housing 12 that is adapted to receive a supply of combustible material, such as wood or charcoal, in the interior 14 of the housing 12. Although not shown, it is contemplated that the housing may include burner elements and be adapted to receive a supply of propane or natural gas to be burned as the heat source. The housing further defines an open upper end 16 and a bottom end 18. The housing, in this embodiment, generally defines a frustoconical shape. In this embodiment, the bottom end 18 is open. An annular shoulder or frustoconical portion 20 is formed and adapted to seat a fire base 22.

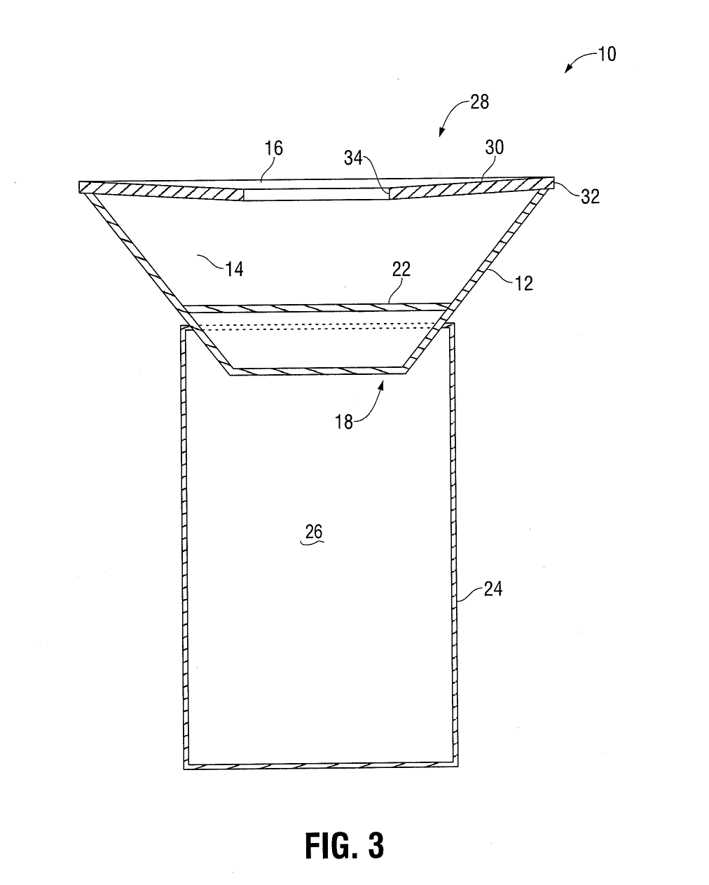

The housing 12 is mounted to a stand 24. In this embodiment, the stand 24 defines an interior section, such as chamber 26 (FIG. 3), into which ash may be deposited. Although not shown, the stand 24 may include separate compartments, such as for cooking utensils, combustible material storage, or the like.

Cooking member 28 is mounted with the housing 12. In this embodiment, the cooking member is permanently mounted to an upper portion of the housing by way of welding. The cooking member 28 defines a top surface 30, an outer periphery 32, and at least one interior opening 34 positioned above the open upper end 16 of the housing 12. In this preferred embodiment, the cooking member 28 is a substantially plate-like member. As shown in this embodiment, the top surface 30 is continuous and uninterrupted. Although depicted as a smooth surface, the top surface 30 may include portions with texturing so as to provide “grill marks” on the food during cooking.

Referring to FIG. 3, the top surface 30 defines a slope. In this embodiment, it is preferred that the outer periphery 32 extends downward towards the interior opening 34 at approximately a 0.3% grade, although the drawing may not accurately represent the downward grade. The grade should be sufficient to allow liquids, such as oil and grease, to travel towards and through the interior opening 34, but not so much as to cause food to slide or roll towards the interior opening 34. As shown in FIG. 3A, in the preferred embodiment, the grade is approximately between 0.2% and 0.6%. In this embodiment, the entirety of the cooking member 28, including its top surface 30, extends downwardly from the outer periphery 32 to the interior opening 34. The slope in the drawing is depicted in an exaggerated form since the desired amount of downward extension in practice would be difficult to observe with the naked eye.

Having the top surface slope towards the interior opening provides several benefits. Grease is allowed to flow towards and through the interior opening. As such, since the food is not directly over the combustible material, any flare ups from the grease will not directly contact the food. Also, because the user is positioned away from the interior opening, the personal danger from flare ups is lessened. In addition, since there is no pooling of grease or oil on the cooking surface, cleanup of the cooking surface is made easier.

In this preferred embodiment, the housing 12 defines a generally frustoconical shape. As such, the combustible material will be concentrated in the central portion of the housing 12. The cooking member 30 then heats up from the center and the outer portion are heated by way of conduction. This results in a higher cooking temperature towards the interior opening 34 than towards the outer periphery 32. Food can thus be cooked at various temperatures all at the same time. For example, it is generally desired to cook meat, such as steak, over high heat, whereas vegetables a preferably cooked over lower heat. Also, because the food is not exposed directly to the heat source, i.e., the fire, the problem of hot spots is reduced.

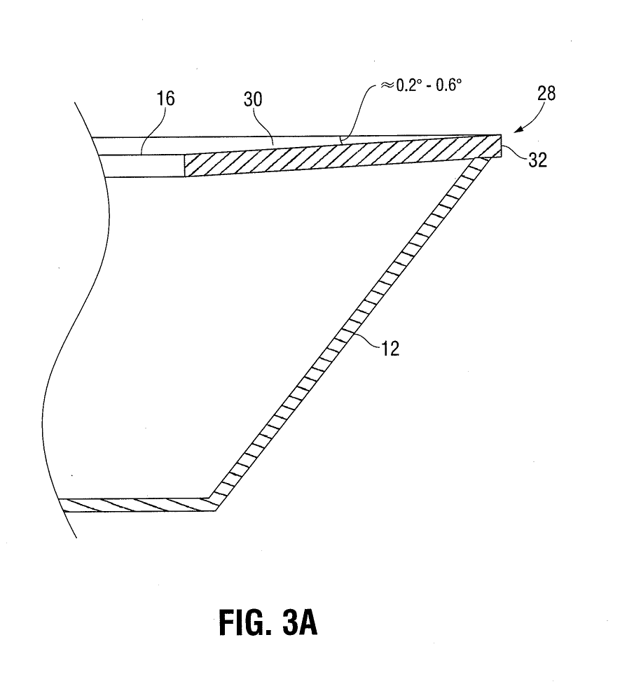

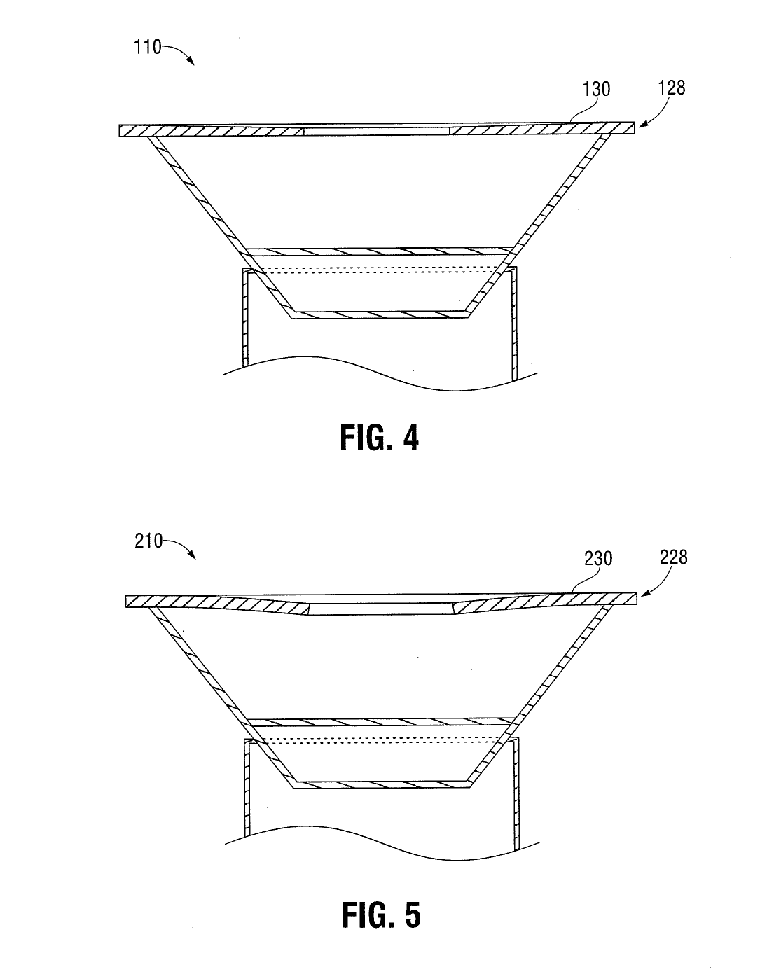

While in FIG. 3, the entire cooking member 28 is sloped, other embodiments are contemplated. Referring to FIG. 4 and cooking apparatus 110, only the top surface 130 of cooking member 128 may be sloped. Referring to FIG. 5, the cooking member 228 of cooking apparatus 210 is curved such that the slope of the top surface 230 is variable. In these embodiments, as well, the grade is sufficient to cause liquids, such as oil and grease, to travel towards and through the interior opening, but not so much as to cause food to slide or roll towards the interior opening, and along the curve, a slope of approximately between 0.2% and 0.6% is preferred. As before, the slope or curvature in the drawings are depicted in an exaggerated form since the desired amount of downward extension in practice would be difficult to observe with the naked eye.

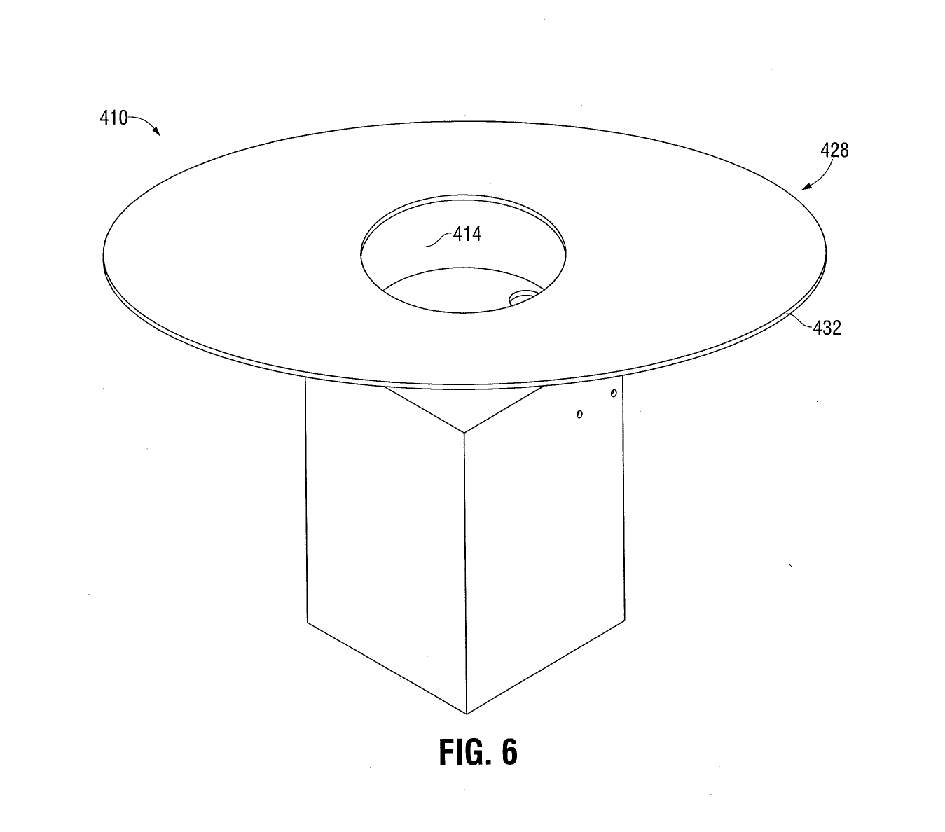

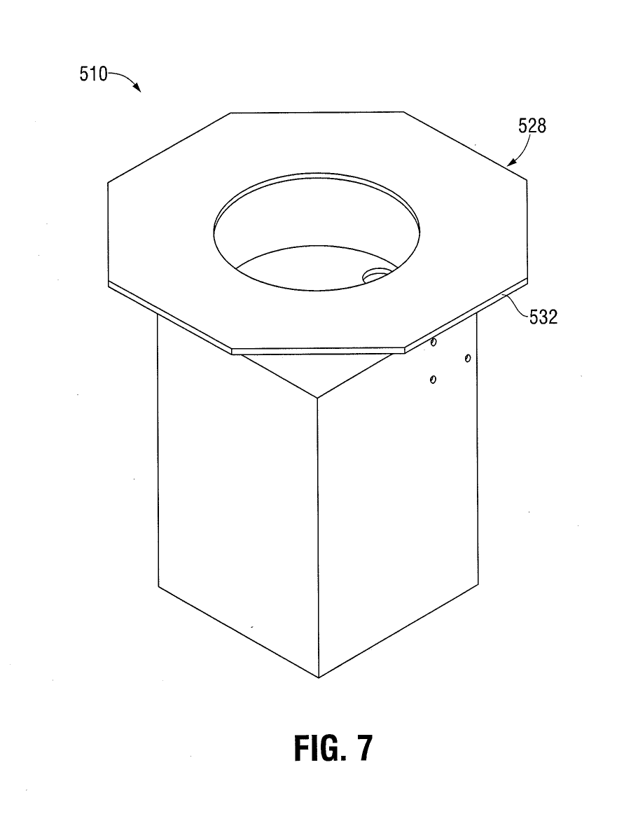

As discussed, in some preferred embodiments, the outer periphery of the cooking member is of a smoothly curved outline, such as a circle. Referring to FIG. 6, an alternative embodiment is shown. In this embodiment, the cooking apparatus 410 comprises a housing (not visible) that is adapted to receive a supply of combustible material in the interior 414 of the housing 412. As before, the housing further defines an open upper end and a bottom end. In this embodiment, the outer periphery 432 of cooking member 428 is of an oval shape. Yet another embodiment is shown in FIG. 7. In this embodiment, the cooking apparatus 510 includes a cooking member 528, wherein the outer periphery 532 of cooking member 528 is octagonal.

While the cooking apparatus is intended to cook food on the top surface, it should be understood that the apparatus may be used in other manners. For example, the apparatus may be used as a fire pit. In addition, the housing and cooking member may also serve as a radiant heat source.

While a presently preferred embodiment of the present invention has been shown and described, it will be apparent that modifications may be made without departing from the scope of the invention as defined in the attached claims.

What is claimed is:

1. A cooking apparatus, the apparatus comprising:
a housing adapted to receive a supply of combustible material, the housing defining an open upper end and a bottom end;
a cooking member mounted with an upper portion of the housing, the cooking member including a top surface, an outer periphery, and an interior opening positioned above the open upper end of the housing;
the top surface being substantially continuous, the top surface further including a portion downwardly extending from the outer periphery to the opening.

2. The cooking apparatus of claim 1, the cooking member comprising a substantially plate-like member.

3. The cooking apparatus of claim 1, the outer periphery defining a substantially circular outline.

4. The cooking apparatus of claim 1, the opening being substantially circular.

5. The cooking apparatus of claim 1, the entire top surface downwardly extending from the outer periphery to the opening.

6. The cooking apparatus of claim 5, the top surface being downwardly sloped.

7. The cooking apparatus of claim 6, the slope having a grade of between about 0.2 degrees and 0.6 degrees.

8. The cooking apparatus of claim 5, the top surface being downwardly curved.

9. The cooking apparatus of claim 1, the housing being of a generally inverted frustoconical shape.

10. A cooking apparatus comprising:
a support stand;
a housing defining an interior, an upper end and a lower end, the lower end of the housing connected with the stand;
a cooktop member having a continuous upper surface and a lower surface, the lower surface connected to the upper end of the housing, the upper surface defining an interior opening, the interior opening defining a first plane, the upper surface further defining an outer periphery, the outer periphery defining a second plane; and
the first plane positioned a first vertical distance from the lower end of the housing, the second plane positioned a second vertical distance from the lower end of the housing, the second vertical distance being greater than the first vertical distance.

11. The cooking apparatus of claim 10, the cooktop member having a substantially uniform thickness.

12. The cooking apparatus of claim 10, the outer periphery defining a substantially circular outline.

13. The cooking apparatus of claim 10, the opening being substantially circular.

14. The cooking apparatus of claim 10, the top surface downwardly sloping from the outer periphery to the interior opening and defining a constant slope.

15. The cooking apparatus of claim 10, the top surface downwardly sloping from the outer periphery to the interior opening and defining a variable slope.

16. A cooking apparatus comprising:
a housing defining an interior, an upper end and a lower end, and adapted to receive combustible material in the interior; and
a cooking member connected with the upper end of the housing, the cooking member defining a top surface and an interior opening, the top surface downwardly extending towards the interior opening.
